(19) United States
(12) Patent Application Publication
(10) Pub. No.: US 2009/0198013 A1
(43) Pub. Date: Aug. 6, 2009

(54) ADHESIVE FILM FOR SEMICONDUCTOR

(76) Inventors: Dong-Cheon Shin, Seoul (KR); Byoung-Un Kang, Gyeonggi-do (KR); Tae-Hyun Sung, Seoul (KR); Jai-Hoon Kim, Seoul (KR); Kyung-Tae Wi, Seoul (KR); Joon-Mo Seo, Gyeonggi-do (KR); Hyuk-Soo Moon, Gyeonggi-do (KR)

Correspondence Address: STROOCK & STROOCK & LAVAN LLP, 180 MAIDEN LANE, NEW YORK, NY, 10038, US

(21) Appl. No.: 11/915,280

(22) PCT Filed: Oct. 31, 2005
(86) PCT No.: PCT/KR2005/003636

§ 371 Date: Jul. 10, 2008

(30) Foreign Application Priority Data
Feb. 25, 2005 (KR) 1020050044218
Sep. 8, 2005 (KR) 1020050083481

(51) Int. Cl. C08L 63/00

(52) U.S. Cl. 524/611

(57) ABSTRACT

An adhesive film for semiconductor is disclosed. The present invention provides an adhesive film for semiconductor used in semiconductor packaging, comprising an adhesive layer, wherein the adhesive layer has surface tension of 19 to 52 erg/cm at 60 ° C. Accordingly, the adhesive film for semiconductor according to the present invention may prevent bubbles from being formed between the adhesive film and a supporting member by controlling surface tension in an optimum condition, and also obtain higher reliability in use of the adhesive film in the semi-conductor packaging by controlling tackiness and adhesive force in an optimum condition.

### TECHNICAL FIELD

The present invention relates to an adhesive film, and more specifically to an adhesive film for semiconductor used for adhering a die to a chip-mounting frame in a process of semiconductor packaging.

### BACKGROUND ART

Generally, a semiconductor packaging process includes a wafer dicing process for cutting a wafer into units of semiconductor chips; a die adhesion process for adhering the cut semiconductor chips onto a chip-mounting frame, for example a lead frame or substrate such as a printed circuit board (PCB) or a tape wiring board, etc.; a wire adhesion process for electrically connecting the chip-mounting frame to the semi-conductor chip; and a packaging process by a epoxy molding compound (EMC) for sealing the semiconductor chip and an adhesive wire.

An adhesive film or an adhesive has been used generally for carrying out bonds between various corresponding elements, for example a semiconductor chip and a substrate, a lead frame and a chip, and a chip and a chip in such a semiconductor packaging process. In the recent years, reduction in weight, thickness, length and size, and high performance of electronic equipment are required in the semiconductor packaging process as a field of electronics/electrics continues to develop. And also a more precisely controllable adhesive continues to be developed in order to facilitate contact between microcircuits, or between a micro-part and a microcircuit.

However, the conventional adhesives is a cause that bubbles are formed in the interface between an adhesive and a supporting member such as a lead frame, substrate or other chip etc., resulting in peeling of package interface due to thermal treatment upon mounting a chip.

Also, a surface-mounting type, which allows the high-density mounting depending on reduction in weight, thickness, length and size of electronic equipment, is mainly used increasingly, but the entire surface-mounting package should be heated because the lead is directly adhered to a printed circuit board in this surface-mounting package. At this time, the package may be cracked by its internal moisture evaporation because it is exposed to high temperature of 200 to 270° C. That is to say, the moisture adsorbed into the adhesive film is vaporized at a mounting temperature, and then cracks are formed between the adhesive film and the supporting member due to pressure by evaporation.

### DISCLOSURE OF INVENTION

### Technical Problem

Therefore, the present invention is designed to solve the problems of the prior art, and it is an object of the present invention to provide an adhesive composition for an adhesive film in the field of semiconductor-packaging, which may prevent bubbles from being formed between an adhesive film and a supporting member by controlling surface tension in an optimum condition, and obtain reliability of semiconductor packaging by controlling tackiness and adhesive force in an optimum condition, and an adhesive film using same.

### Technical Solution

In order to accomplish the above object, the present invention provides an adhesive film to be used in a semiconductor packaging, comprising an adhesive layer; wherein the adhesive layer has surface tension of 19 to 52 erg/cm² at 60° C.

Preferably, the adhesive layer may have tackiness of 50 to 400 gf/Ø5.0 mm at 60 ° C.

More preferably, the adhesive layer may have adhesive force of at least 5 gf/cm².

Meanwhile, the adhesive layer preferably includes at least one material selected from the group consisting of an epoxy-based resin, an organic filler, an inorganic filler and a curing agent, and further may include at least one modifier selected from the group consisting of a amino-based compound, a silane-based compound, an acrylic compound, metal organic salt, silicon oxide and titanium oxide.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a cross-sectional view showing an adhesive film according to a preferred embodiment of the present invention.

### BEST MODE FOR CARRYING OUT THE INVENTION

Hereinafter, preferred embodiments of the present invention will be described in detail referring to the accompanying drawing. Prior to the description, it should be understood that the terms used in the specification and appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

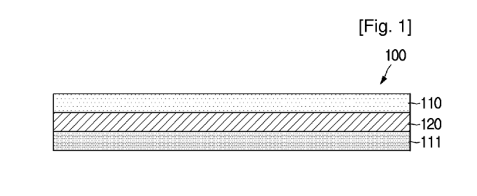

FIG. 1 is a cross-sectional view showing an adhesive film according to a preferred embodiment of the present invention.

Referring to FIG. 1, an adhesive film 100 according to this embodiment includes a base film 110; an adhesive layer 120 adhered to one surface of the base film 110; and a protective film 111 adhered to the other surface of the adhesive layer 120. The protective film 111 functions to protect the adhesive layer 120.

The base film 110, which maintains a basic form of the adhesive film, may preferably include polyethylene terephthalate (PET) or polyethylene- polyethylene-2,6-naphthalenedicarboxylate (PEN).

The protective film 111, which protects the adhesive layer from foreign substances, may preferably include polyethylene or polyethylene terephthalate (PET).

The adhesive layer 120 is adhered between a die and a supporting member, for example a lead frame, a substrate or other dies after the base film 110 and the protective film 111 are removed.

An adhesive film 100 is laminated into the supporting member at a ranges of 60 to 80° C., or pressed into the supporting member at a ranges of 110 to 130° C. In this case, bubbles may be generated between the adhesive film and the supporting member if surface tension of an adhesive layer 120 in the adhesive film 100 is widely different to that of the supporting member in the lamination process. Accordingly, surface tension of the adhesive layer 120 is set to surface tension of the supporting member, for example a range of 19 to 52 erg/cm² to give a smooth surface and good wetness of the supporting member.

Preferably, tackiness of the adhesive layer 120 is set to 50 to 400 gf/Ø05.0 mm. It is because that if the adhesive layer 120 has tackiness of less than 50 gf/Ø5.0 mm, the supporting member and the adhesive film 100 may not be sufficiently adhered each other, causing formation of bubbles in their interface, and that if the adhesive layer 120 has tackiness of at least 400 gf/Ø5.0 mm, it may have a disadvantage that a double-faced adhesive film is strongly adhered to and not detached from the equipment.

More preferably, the adhesive layer 120 has adhesive force of at lease 5 gf/cm². If it has adhesive force of less than 5 gf/cm², it is difficult to obtain enough adhesive force to prevent bubbles being formed in surfaces of the adhesive layer 120 during the adhesion process.

Meanwhile, a composition constituting the adhesive layer 120 may includes at least one material selected from the group consisting of an epoxy-based resin, an organic filler, a curing agent and an inorganic filler. The epoxy-based resin may be preferably used by mixing a solid-phase epoxy resin and a liquid-phase epoxy resin. And bisphenol A, bisphenol F, a phenoxy resin or a cresol novolac resin may be also used. Such epoxy resin may give a high adhesive strength, and has very low reaction shrinkage and no generation of volatile materials. Also it has excellent properties such as a mechanical property, an electric insulating property, water resistance, and thermal resistance.

The organic filler may include polyimide, polyamideimide, polyesterimide, nylon, or silicon resin etc. The inorganic filler may include silica, aluminum nitride, or alumina etc. The curing agent may include amines, anhydrides, or amides etc., and further include a latent curing agent and a curing agent with high melting point. Preferably, the adhesive layer may further include a metal filler to give an electro-conductive property.

In addition, a composition constituting the adhesive layer 120 preferably includes at least one modifier selected from the group consisting of a amino-based compound, a silane-based compound, an acrylic compound, metal organic salt, silicon oxide and titanium oxide. Such modifier may be added to adjust surface tension, tackiness, and adhesive force of the adhesive layer 120 in an optimum condition.

However, the present invention is not limited to the materials, but various changes and modifications within the spirit and scope of the invention may be adapted by those skilled in the art from this detailed description.

Hereinafter, the present invention will be described in detail with specific example. However, it should be understood that the detailed description and specific examples according to preferred embodiments of the invention, are given by way of illustration only, since various changes and modifications within the spirit and scope of the invention will become apparent to those skilled in the art from this detailed description.

A solid-phase epoxy resin, a liquid-phase epoxy resin, an organic filler, an epoxy curing agent, a UV-curing agent and a UV-curing formulation were mixed in a constant ratio in Examples 1 to 3, and Comparative examples 1 and 2, and various modifiers were further added and mixed in Examples 1 to 3. Subsequently, each mixture was coated into a 50 □-thick polyester film in thickness about 25 □. Ratios of such compositions of Examples and Comparative examples are listed in Table 1 as follows.

TABLE 1

| | Example | | | Comparative example | |
|---|---|---|---|---|---|
| | 1 | 2 | 3 | 1 | 2 |
| Solid-phase epoxy | 35 | 35 | 40 | 30 | 40 |
| Liquid-phase epoxy | 30 | 30 | 25 | 35 | 25 |
| Organic filler | 29 | 29 | 29 | 29 | 29 |
| Modifier | 1 phr | 5 phr | 10 phr | 0 phr | 15 phr |
| Epoxy curing agent | 4 phr | 4 phr | 4 phr | 4 phr | 4 phr |
| UV-curing agent | 6 phr | 6 phr | 6 phr | 6 phr | 6 phr |
| UV-curing formulation | 6 | 6 | 6 | 6 | 6 |

In compositional ratios of Examples and Comparative examples listed in the Table 1, the modifier, the epoxy curing agent, and the UV-curing agent were added in “part by weight”, based on 100% by weight of a solid-phase epoxy, a liquid-phase epoxy, an organic filler and a UV-curing formulation.

Surface tension, tackiness, and 180° peel strength of Examples 1 to 3, Comparative examples 1 and 2 having the compositions listed in the Table 1 were measured and the results are listed in Table 2.

TABLE 2

| | | Example | | | Comparative example | |
|---|---|---|---|---|---|---|
| | | 1 | 2 | 3 | 1 | 2 |
| Surface tension (60° C.)(erg/□) | | 52 | 39 | 19 | 58 | 13 |
| Tackiness (60° C.) (gf) | | 102 | 89 | 82 | 330 | 55 |
| 180° peel strength | 60° C. | 150 | 110 | 75 | 130 | 10 |
| (gf/cm)(adhesive force) | After | 1,100 | 1,120 | 580 | 450 | 320 |
| | cured | | | | | |

| | | | | | |
|---|---|---|---|---|---|
| MRT test(JEDEC Level | Passed | Passed | Passed | No passed | No passed |
| 1Pb-free) | | | | | |

Referring to Table 2, the compositions of Examples 1 to 3 having surface tension of 19 to 52 erg/cm² showed an excellent properties when MRT test was carried out according to a procedure specified in JEDEC. That is to say, a good wetness of the supporting member also possibly prevents the bubbles being generated between the adhesive film and a supporting member, which eventually prevents cracking of the semiconductor package. Also as shown in Table 2, tackiness and adhesive force may be maintained at a suitable level to prevent the adhesive layer from remaining in the press machine due to excessive tackiness in a pressing process of the adhesive film.

The present invention has been described in detail. However, it should be understood that the detailed description and specific examples according to preferred embodiments of the invention, are given by way of illustration only, since various changes and modifications within the spirit and scope of the invention will become apparent to those skilled in the art from this detailed description.

### INDUSTRIAL APPLICABILITY

As been described above, the adhesive film for semiconductor according to the present invention may be useful to prevent bubbles from being formed between the adhesive film and a supporting member by controlling surface tension in an optimum condition and also obtain higher reliability in use of the adhesive film in semi-conductor packaging by controlling tackiness and adhesive force in an optimum condition.

1. An adhesive film for semiconductor used in a semiconductor packaging, comprising an adhesive layer;
wherein the adhesive layer has surface tension of 19 to 52 erg/cm² at 60° C.

2. The adhesive film for semiconductor according to the claim 1, wherein the adhesive layer has tackiness of 50 to 400 gf/Ø5.0 mm at 60° C.

3. The adhesive film for semiconductor according to the claim 1, wherein the adhesive layer has adhesive force of at least 5 gf/cm².

4. The adhesive film for semiconductor according to claim 1,
wherein the adhesive layer includes at least one material selected from the group consisting of an epoxy-based resin, an organic filler, an inorganic filler and a curing agent.

5. The adhesive film for semiconductor according to the claim 4, wherein the adhesive layer further includes at least one modifier selected from the group consisting of a amino-based compound, a silane-based compound, an acrylic compound, metal organic salt, silicon oxide and titanium oxide.

6. The adhesive film for semiconductor according to claim 2, wherein the adhesive layer includes at least one material selected from the group consisting of an epoxy-based resin, an organic filler, an inorganic filler and a curing agent.

7. The adhesive film for semiconductor according to claim 3, wherein the adhesive layer includes at least one material selected from the group consisting of an epoxy-based resin, an organic filler, an inorganic filler and a curing agent.

8. The adhesive film for semiconductor according to the claim 6, wherein the adhesive layer further includes at least one modifier selected from the group consisting of a amino-based compound, a silane-based compound, an acrylic compound, metal organic salt, silicon oxide and titanium oxide.

9. The adhesive film for semiconductor according to the claim 7, wherein the adhesive layer further includes at least one modifier selected from the group consisting of a amino-based compound, a silane-based compound, an acrylic compound, metal organic salt, silicon oxide and titanium oxide.
